(19) United States
(12) Patent Application Publication
(10) Pub. No.: US 2024/0387885 A1
(43) Pub. Date: Nov. 21, 2024

(54) BATTERY AND ELECTRODE

(71) Applicant: TOYOTA JIDOSHA KABUSHIKI KAISHA, Toyota-shi (JP)

(72) Inventor: Shuhei KOYAMA, Toyota-shi (JP)

(73) Assignee: TOYOTA JIDOSHA KABUSHIKI KAISHA, Toyota-shi (JP)

(21) Appl. No.: 18/617,694

(22) Filed: Mar. 27, 2024

(30) Foreign Application Priority Data
May 16, 2023 (JP) 2023-080521

(51) Int. Cl. H01M 10/42; H01M 4/66

(52) U.S. Cl. CPC H01M 10/4235; H01M 4/661

(57) ABSTRACT

A battery according to an aspect of the present disclosure includes an electrode layer having a groove structure and a current collector including the electrode layer having the groove structure on at least one surface thereof. The current collector includes two plate-like members and a column. Each of the two plate-like members has an electrode layer on one surface thereof and opposes each other on the other surface thereof. The column is arranged along the groove structure and configured to connect the other surfaces of the two plate-like members.

### CROSS REFERENCE TO RELATED APPLICATIONS

This application is based upon and claims the benefit of priority from Japanese patent application No. 2023-080521, filed on May 16, 2023, the disclosure of which is incorporated herein in its entirety by reference.

### BACKGROUND

The present disclosure relates to a battery and an electrode.

Japanese Unexamined Patent Application Publication No. 2019-021513 describes a power storage apparatus including a power storage module configured by laminating bipolar electrodes, a restraining plate for restraining a power storage module in the lamination direction, and an elastic body disposed between the power storage module and the restraining plate.

The power storage apparatus described in Japanese Patent Unexamined Patent Application Publication No. 2019-021513 has a configuration in which an elastic body is disposed between a power storage module and a restraining plate, thereby uniformizing surface pressure applied on the power storage module.

### SUMMARY

In a bipolar electrode such as the one described in Japanese Patent Unexamined Patent Application Publication No. 2019-021513, in order to discharge gas generated in manufacturing the power storage apparatus, a positive electrode layer provided in the power storage apparatus may have a groove structure.

In this case, the thickness of the positive electrode layer in the lamination direction near the groove structure is apt to be thinner than that at other positions.

When the height of the positive electrode layer in the lamination direction differs depending on the position of the positive electrode layer, a non-uniform surface pressure is applied on the positive electrode layer. When a non-uniform surface pressure is applied on the positive electrode layer, gas generated in manufacturing the power storage apparatus may accumulate at a position where the surface pressure is low, causing degradation in the battery performance.

Japanese Patent Unexamined Patent Application Publication No. 2019-021513 does not disclose any technique that can solve the aforementioned problem.

The present disclosure is made to solve such a problem, and an object of the present disclosure is to provide a battery and an electrode in which degradation in the battery performance can be suppressed.

A battery according to an aspect of the present disclosure includes:
an electrode layer having a groove structure; and
a current collector including the electrode layer having the groove structure on at least one surface,
the current collector including:
two plate-like members each having an electrode layer on one surface thereof and opposing each other on the other surface thereof; and
a column arranged along the groove structure and configured to connect the other surfaces of the two plate-like members.

According to such a configuration, even in the vicinity of the groove structure where the thickness of the electrode layer is thin, a surface pressure applied by the current collector to the electrode layer is maintained, so that generation of gas accumulation can be suppressed in the battery according to one aspect of the present disclosure.

As a result, it is possible to suppress degradation in battery performance of the battery according to an aspect of the present disclosure.

In the battery according to an aspect of the present disclosure, the plate-like member may be an elastic body.

With such a configuration, the surface pressure of an abutment surface between the electrode layer and the current collector increases, whereby gas accumulation can be suppressed even more in the battery according to one aspect of the present disclosure.

The battery according to an aspect of the present disclosure may have a configuration in which a width of the column is less than a width of the groove structure.

With such a configuration, the surface pressure of an abutment surface between the electrode layer and the current collector increases, thereby gas accumulation can be suppressed even more in the battery according to one aspect of the present disclosure.

The battery according to an aspect of the present disclosure may have a configuration in which a coolant flows inside the current collector.

With such a configuration, the battery according to an aspect of the present disclosure can suppress rise in a temperature during operation thereof, thereby it is possible to suppress decrease in the battery performance.

An electrode according to an aspect of the present disclosure includes:
an electrode layer having a groove structure; and
a current collector including the electrode layer having the groove structure on at least one surface thereof,
the current collector including:
two plate-like members each having an electrode layer on one surface thereof and opposing each other on the other surface thereof; and
a column arranged along the groove structure and configured to connect the other surfaces of the two plate-like members.

According to the present disclosure, it is possible to provide a battery and an electrode in which degradation in the battery performance can be suppressed.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic cross-sectional diagram showing a configuration of a battery according to a first embodiment;

FIG. 2 is a schematic plan view showing a configuration of the battery according to the first embodiment;

FIG. 3 is a schematic cross-sectional diagram showing a configuration of the battery according to the first embodiment; and

FIG. 4 is a schematic cross-sectional diagram showing a configuration of the battery according to the first embodiment.

### DESCRIPTION OF EMBODIMENTS

### First Embodiment

### <Battery Configuration>

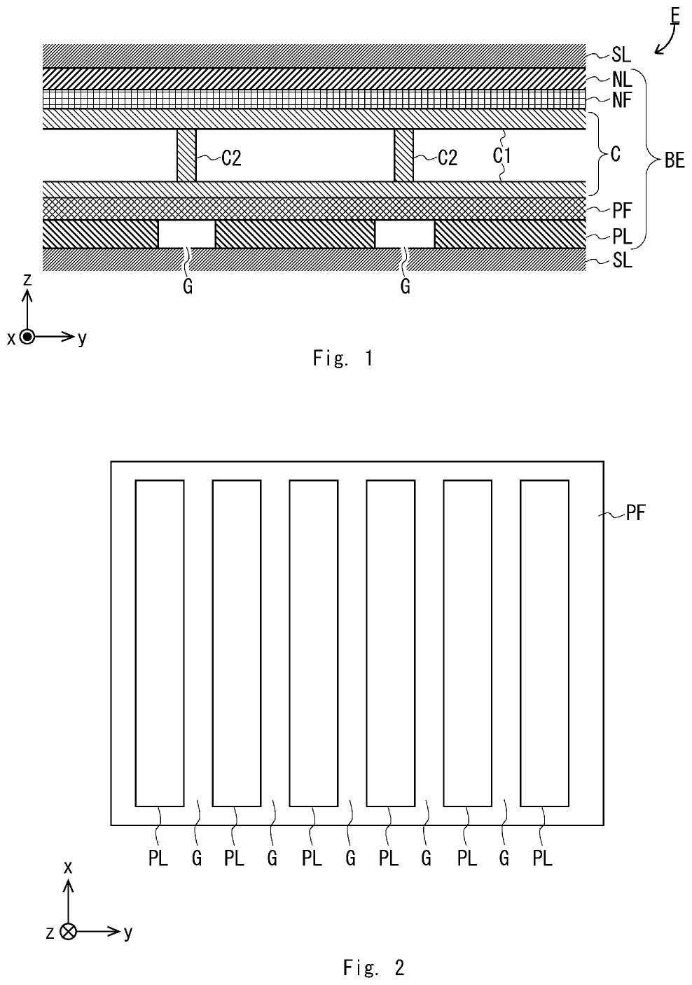

A first embodiment according to the present disclosure will now be described in detail with reference to the drawings. First, a configuration of a power storage apparatus according to the present embodiment will be described in detail. FIG. 1 is a schematic cross-sectional diagram showing a configuration of a battery according to the first embodiment.

It should be noted that, of course, the right-handed xyz orthogonal coordinates shown in FIG. 1 and other drawings are shown for the sake of convenience in explaining the positional relationship of the structural elements. In general, the positive z-axis direction is vertically upward and the xy-plane is a horizontal plane, which are common among the drawings.

As shown in FIG. 1, a battery E according to the first embodiment has a configuration in which a bipolar electrode BE and a separator layer SL are alternately laminated.

The bipolar electrode BE and the separator layer SL are restrained in the lamination direction, i.e., in the positive direction of the z-axis, by a restraining jig (not shown). The bipolar electrode BE and the separator layer SL are surface pressure mounted in the positive direction of the z-axis by the restraining jig.

The separator layer SL prevents short circuits between the bipolar electrodes BE.

The material of the separator layer SL may be any material that functions as a separator of a battery.

Specific examples of the material of the separator layer SL include, for example, a porous film or a nonwoven fabric mainly composed of a polyolefin-based resin such as polyethylene (PE) or polypropylene (PP).

The separator layer SL also contains an electrolyte and functions as an electrolyte layer.

The electrolyte contained in the separator layer SL may be any solution that functions as an electrolyte for a battery.

Specific examples of a solvent of the electrolyte contained in the separator layer SL include cyclic carbonates, cyclic esters, chain carbonates, chain esters, ethers, and mixtures thereof. Further, specific examples of solutes of the electrolyte contained in the separator layer SL include LiBF₄, LiPF₆, LiN(FSO₂)₂, LiN(SO₂CF₃)₂, LiN(SO₂C₂F₅)₂, and mixtures thereof.

The bipolar electrode BE includes a current collector C, a positive electrode layer PL, a positive electrode foil PF, a negative electrode layer NL, and a negative electrode foil NL.

The positive electrode layer PL and the negative electrode layer NL may be collectively referred to as an electrode layer.

The electrode according to the present disclosure includes an electrode layer having a groove structure and a current collector having an electrode layer having a groove structure on at least one surface thereof.

In the present embodiment, the positive electrode layer PL corresponds to an electrode layer having a groove structure. In the present embodiment, the current collector C corresponds to a current collector having an electrode layer having a groove structure on at least one surface thereof.

The positive electrode layer PL is a layer formed on the surface of the current collector C with the positive electrode foil PF in between and has a groove structure G.

FIG. 2 is a schematic plan view showing a configuration of the battery according to the first embodiment, in which the positive electrode layer PL and the positive electrode foil PF are viewed from the negative z-axis direction.

As shown in FIG. 2, the positive electrode layer PL is formed on the positive electrode foil PF in a plurality of sections thereof. Between the sections where the positive electrode layers PL are formed, there exists the groove structure G, which is a part where the positive electrode layers PL are not formed.

The groove structure G may be regarded as a part of an electrode layer.

Further, the groove structure G is provided for discharging gas generated from the positive electrode layer PL to the outside in manufacturing the battery E.

The positive electrode layer PL may be formed by, for example, coating the current collector C with the positive electrode slurry through the positive electrode foil PF and drying it.

Further, the groove structure G may be formed by, for example, applying the positive electrode slurry only to the aforementioned plurality of sections of the positive electrode layer PL in forming the positive electrode layer PL.

Further, the groove structure G may be formed by, for example, peeling a part of the positive electrode layer PL that has been formed.

The thickness of the positive electrode layer PL in the z-axis direction in the vicinity of the groove structure G is thinner than that at other positions. That is, the thickness of the positive electrode layer PL is non-uniform.

As will be described in detail later, a surface pressure is applied on the positive electrode layer PL from a plate-like member C1 which is curved according to the thickness of the positive electrode layer PL.

The positive electrode layer PL contains a positive electrode active material.

The positive electrode active material contained in the positive electrode layer PL may be any material that is usable as a positive electrode active material of a battery.

Specific examples of a positive electrode active material contained in the positive electrode layer PL include LiCoO₂, LiNiO₂, LiMn₂O₄, LiNiₓCo_{y}O₂, LiNiₓCo_{y}Al_{z}O₂, LiNiₓCo_{y}Mn_{z}O₂, LiFePO₄, and the like. In the composition formula, x, y, and z are real numbers equal to or greater than 0.

The positive electrode layer PL may contain a conductive aid.

The conductive aid contained in the positive electrode layer PL may be any material that is usable as a conductive aid of a battery.

Specific examples of a conductive aid contained in the positive electrode layer PL include carbon materials such as acetylene black, carbon black, and graphite.

The positive electrode layer PL may also contain a binding agent.

The binding agent contained in the positive electrode layer PL may be any material that is usable as a binding agent of the battery.

Specific examples of a binding agent contained in the positive electrode layer PL include fluorine-containing resin, thermoplastic resin, imide resin, alkoxy silyl group-containing resin, acrylic resin, etc.

The positive electrode foil PF is a thin film disposed on the surface of the current collector C and is typically a metal layer. The positive electrode layer PL is formed on the positive electrode foil PF.

The positive electrode foil PF is a thin film disposed on the surface of the plate-like member C1, which will be described later, and is curved in accordance with the curvature of the plate-like member C1.

The positive electrode foil PF may be omitted. That is, the positive electrode layer PL may be formed directly on the current collector C.

The negative electrode layer NL is a layer formed on the surface of the current collector C via the negative electrode foil NF and contains a negative electrode active material.

The negative electrode active material contained in the negative electrode layer NL may be any material that is usable as a negative electrode active material of the battery.

Specific examples of a negative electrode active material contained in the negative electrode layer NL include carbon such as graphite, graphite, mesocarbon microbeads, hard carbon, and soft carbon, metal compounds, elements or compounds thereof that can be alloyed with lithium, boron-added carbon, and the like. Specific examples of an element that can be alloyed with lithium include silicon (silicon) and tin.

The negative electrode layer NL may contain a conductive aid.

The conductive aid contained in the negative electrode layer NL may be any material that can is usable as a conductive aid of a battery.

Note that specific examples of a conductive aid contained in the negative electrode layer NL are similar to the specific examples of a conductive aid contained in the positive electrode layer PL.

The negative electrode layer NL may optionally contain a binding agent.

The binding agent contained in the negative electrode layer NL may be any material that is usable as a binding agent of a battery.

Note that specific examples of a binding agent contained in the negative electrode layer NL are similar to the specific example of a conductive aid contained in the positive electrode layer PL.

The negative electrode foil NF is a thin film disposed on the surface of the current collector C and is typically a metal layer. The negative electrode layer NL is formed on the negative electrode foil NF.

Note that the negative electrode foil NF may be omitted. That is, the negative electrode foil NF may be formed directly on the current collector C.

The current collector C includes two plate-like members C1 and a column C2.

The current collector C includes, on one surface thereof, the positive electrode layer PL with the positive electrode foil PF in between. The current collector C includes, on the other surface thereof, the negative electrode layer NL with the negative electrode foil NF in between.

The current collector C outputs the electric power generated by the positive electrode layer PL and the negative electrode layer NL to the outside.

Each of the plate-like members C1 is a conductive member and has an electrode layer on one surface thereof and opposes each other on the other surface thereof. The opposing surfaces of the plate-like members are connected by the column C2, which will be described later.

That is, the current collector C is composed of two laminated plate-like members C1, and the two plate-like members C1 are connected by the column C2.

The plate-like member C1 according to the present embodiment has the positive electrode layer PL formed on the surface thereof with the positive electrode foil PF in between and the negative electrode layer NL formed on the surface thereof with the negative electrode foil NF in between.

More specifically, the plate-like member C1 disposed on the z-axis positive side has the positive electrode layer PL and the plate-like member C1 formed on the z-axis negative side has the negative electrode layer NL.

The plate-like member C1 is bent by a force in the z-axis direction from the column C2 and a surface pressure is applied on the electrode layer. Therefore, the plate-like member C1 be preferably a conductive elastic body.

An example of an elastic body having conductivity is a thin metal plate.

Specific examples of a thin metal plate that can be used as the plate-like member C1 include stainless steel, iron, copper, aluminum, titanium, nickel, and alloys containing two or more of these materials.

Note that the two plate-like members C1 may be made of different materials.

In the present embodiment, an electrode layer having a groove structure G, i.e., the plate-like member C1 having the positive electrode layer PL, may be curved, and the other plate-like member C1 may be rigid.

The column C2 is disposed on the side of the plate-like member C1 that does not have an electrode layer and connects the two plate-like members C1. The column C2 is made of a conductive material and electrically connects the two plate-like members C1.

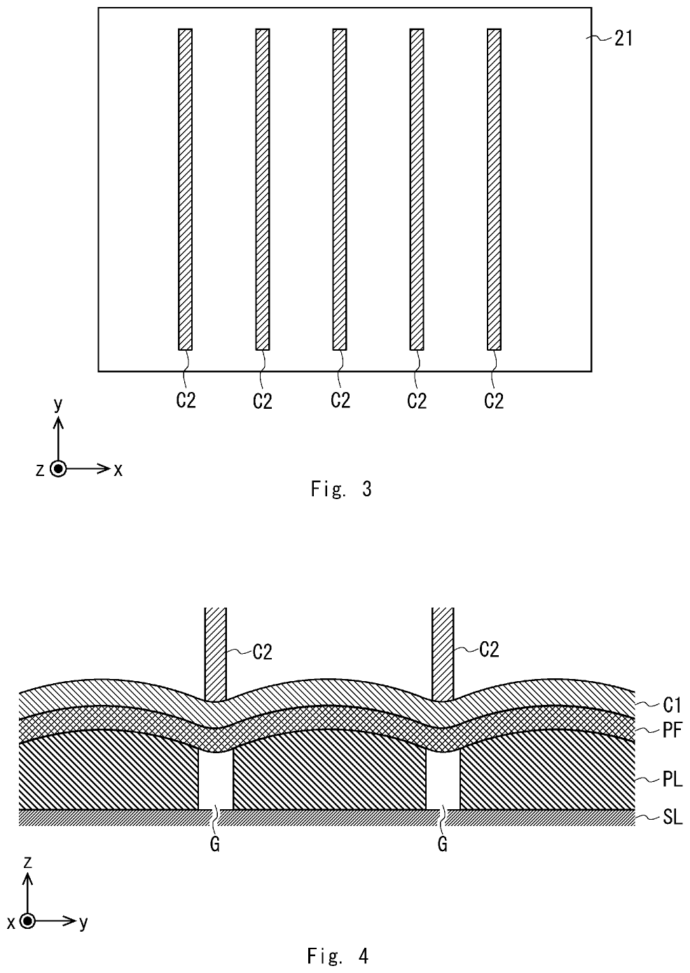

FIG. 3 is a schematic cross-sectional diagram showing a configuration of the battery according to the first embodiment. More specifically, FIG. 3 is a diagram in which the column C2 is cut along a plane parallel to the xy-plane, and the plate-like member C1 and the columns C2 on the z-axis negative side are viewed in the positive direction of the z-axis.

It can be said that FIG. 3 is a diagram illustrating the configuration of the rear surface side of the plane shown in FIG. 2.

FIG. 4 is a schematic cross-sectional diagram showing a configuration of the battery according to the first embodiment. More specifically, FIG. 4 is a diagram showing the battery 1 cut along a plane parallel to the yz-plane, in which the plate-like member C1 on the z-axis negative side, the column C2, the positive electrode foil PF, the positive electrode layer PL, and the separator layer SL on the z-axis negative side are viewed in the positive direction of the x-axis.

As shown in FIGS. 3 and 4, the column C2 is disposed along the groove structure G provided on the rear surface side of the plane.

As shown in FIG. 3, the column C2 is formed as a linear member that extends in one direction parallel to the main surface side of the plate-like member C1, that is, in the y-axis direction.

As described above, the thickness of the positive electrode layer PL is thin in the vicinity of the groove structure G.

Therefore, the column C2 according to the present embodiment applies a force to the plate-like member C1, and as shown in FIG. 4, the plate-like member C1 and the positive electrode foil PF are bent so as to sink into the groove structure G.

With such a configuration, the surface pressure applied by the plate-like member C1 to the positive electrode layer PL is maintained even in the vicinity of the groove structure G where the thickness of the positive electrode layer PL is thin.

When the surface pressure applied to the positive electrode layer PL is maintained, generation of gas accumulation between the positive electrode layer PL and the current collector C is suppressed. As a result, degradation in the performance of the battery E can be suppressed.

Here, the width of the column C2 in the direction perpendicular to the lamination direction, that is, in the y-axis direction, may be configured to be less than the width of the groove structure G in the y-axis direction, as shown in FIG. 4.

Further, as shown in FIG. 4, the position of the column C2 may be adjusted so that the positive electrode layer PL does not exist on the rear surface side of the plane at a position where the film is formed.

With such a configuration, the surface pressure of an abutment surface between the positive electrode layer PL and the positive electrode foil PF increases, whereby generation of gas accumulation can be suppressed even more in the battery E.

As described above, in the battery E according to the present embodiment, the column C2 disposed along the groove structure G bends the plate-like member C1 so as to sink into the groove structure G.

With such a configuration, even in the vicinity of the groove structure G where the thickness of the positive electrode layer PL is thin, the surface pressure applied by the plate-like member C1 to the positive electrode layer PL is maintained.

Since the surface pressure applied to the positive electrode layer PL is maintained even in the vicinity of the groove structure G, generation of gas accumulation can be suppressed in the battery E according to the present embodiment. As a result, degradation in the battery performance can be suppressed in the battery E according to the present embodiment.

### OTHER EMBODIMENTS

The battery E according to the first embodiment was provided with a bipolar electrode, but the battery according to the present disclosure is not limited thereto.

For example, the battery E may have an electrode provided with the positive electrode layer PL on both sides of the current collector C and an electrode provided with the negative electrode layer NL on both sides of the current collector C, which are alternately laminated via the separator layer SL.

In the battery E according to the first embodiment, only the positive electrode layer PL has the groove structure G, but only the negative electrode layer NL may have the groove structure G, or both the positive electrode layer PL and the negative electrode layer NL may have the groove structure G.

In the battery E according to the first embodiment, an electrode layer having a groove structure is provided on only one side of the current collector C, but the current collector C may have an electrode layer having a groove structure on both sides thereof. That is, the current collector C may have an electrode layer having a groove structure on at least one side.

The battery E according to the first embodiment is configured by using only an electrode composed of an electrode layer having the groove structure G and the current collector C having the plate-like member C1 and the column C2. However, the configuration of the battery according to the present disclosure is not limited thereto.

For example, the battery according to the present disclosure may be configured by combining the electrode disclosed herein with a generally used electrode.

The battery E according to the present disclosure may flow a coolant into the current collector C, i.e., into a space surrounded by the two plate-like members C1 and the column C2.

With such a configuration, it is possible to suppress generation of heat in the battery in operation. As a result, it is possible to suppress degradation in battery performance of the battery E.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A battery comprising:
an electrode layer having a groove structure; and
a current collector including the electrode layer having the groove structure on at least one surface thereof,
the current collector including:
two plate-like members each having an electrode layer on one surface thereof and opposing each other on the other surface thereof; and
a column arranged along the groove structure and configured to connect the other surfaces of the two plate-like members.

2. The battery according to claim 1, wherein the plate-like member is an elastic body,

3. The battery according to claim 1, wherein a width of the column is less than a width of the groove structure.

4. The battery according to claim 1, wherein a coolant flows inside the current collector.

5. An electrode comprising:
an electrode layer having a groove structure; and
a current collector including the electrode layer having the groove structure on at least one surface thereof,
the current collector including:
two plate-like members each having an electrode layer on one surface thereof and opposing each other on the other surface thereof; and
a column arranged along the groove structure and configured to connect the other surfaces of the two plate-like members.
